(19) United States
(12) Patent Application Publication
(10) Pub. No.: US 2012/0331511 A1
(43) Pub. Date: Dec. 27, 2012

(54) INTELLIGENT CAR A/V SYSTEM

(76) Inventor: Shih-Yao CHEN, New Taipei City (TW)

(21) Appl. No.: 13/168,946

(22) Filed: Jun. 25, 2011

(51) Int. Cl. H04N 7/18

(52) U.S. Cl. 725/75

(57) ABSTRACT

An intelligent car A/V system includes a main unit installed in a center console of a dashboard of a car and having built therein a control system, a power converter, a FM/AM receiver module, a digital TV receiver module, a DVD/SD/USB multimedia player module, a car camcorder, a reversing video display type driver assistance system, a GPS receiver module and an audio amplifier system, and a tablet PC electrically connectable to the control system of the main unit for operation under the control of the control system and having built therein an operating system, a satellite-based navigation system, a system operation control software, a wireless network communication system, a display system, a touch control system, a multimedia/entertainment DVD player system and an internet operating system.

### BACKGROUND OF THE INVENTION

1. Field of the Invention

The present invention relates to car A/V systems and more particularly, to an intelligent car A/V system, which combines a main unit and a table PC for use in a car for multimedia data-playing application, satellite-based navigation application, wireless communication application as well as many other internet applications.

2. Description of the Related Art

A car generally has an A/V (audio/video) system installed therein for audio/video data playing application. A car A/V system generally comprises a main unit and a touch panel hinged to the front side of the main unit for touch control and video output.

However, the touch panel of a regular car A/V system is not detachable for other applications. Thus, the application of the touch panel of a regular car A/V system is limited.

Further, tablet PC has been a hot pursuit and new fashion. Combining a tablet PC into a car A/V system broadens the functions of the car A/V system and can attract people to buy the system.

### SUMMARY OF THE INVENTION

The present invention has been accomplished under the circumstances in view. It is one object of the present invention to provide an intelligent car A/V system for use in a car, which combines a tablet PC into a car A/V system, broadening the functions of the car A/V system.

To achieve this and other objects of the present invention, an intelligent car A/V system comprises a main unit and a tablet PC for use as a terminal of the main unit. The main unit is installed in the center console of the dashboard of a car, comprising a control system, a power converter electrically connected with the control system and electrically connectable to a battery power circuit of the car to obtain car battery power from the car and to convert the obtained car battery power into a desired voltage level for the control system, and a FM/AM receiver module, a digital TV receiver module, a DVD/SD/USB multimedia player module, a car camcorder, a reversing video display type driver assistance system, a GPS receiver module and an audio amplifier system respectively electrically connected with the control system. The tablet PC is detachably mountable at the center console of the dashboard of the car and electrically connected to the control system of the main unit for operation subject to the control of the control system, comprising an operating system, a satellite-based navigation system, a system operation control software, a wireless network communication system, a display system, a touch control system, a multimedia/entertainment DVD player system and an internet operating system.

After connection of the tablet PC to the control system of the main unit, the tablet PC is used as an audio/video terminal of the main unit for audio/video data output.

After disconnection of the tablet PC from the main unit, the tablet PC is used as an independent personal computer that has the main characteristics of a conventional personal computer.

### BRIEF DESCRIPTION OF THE DRAWINGS

FIG. 1 is a schematic drawing illustrating the outer appearance of an intelligent car A/V system in accordance with a first embodiment of the present invention.

FIG. 2 is a system block diagram of the intelligent car A/V system in accordance with the first embodiment of the present invention.

FIG. 3 is a schematic drawing illustrating the intelligent car A/V system installed in a car in accordance with the first embodiment of the present invention.

FIG. 4 is an exploded view of an intelligent car A/V system in accordance with a second embodiment of the present invention.

FIG. 5 is an elevational assembly view of the intelligent car A/V system in accordance with the second embodiment of the present invention.

### DETAILED DESCRIPTION OF THE PREFERRED EMBODIMENT

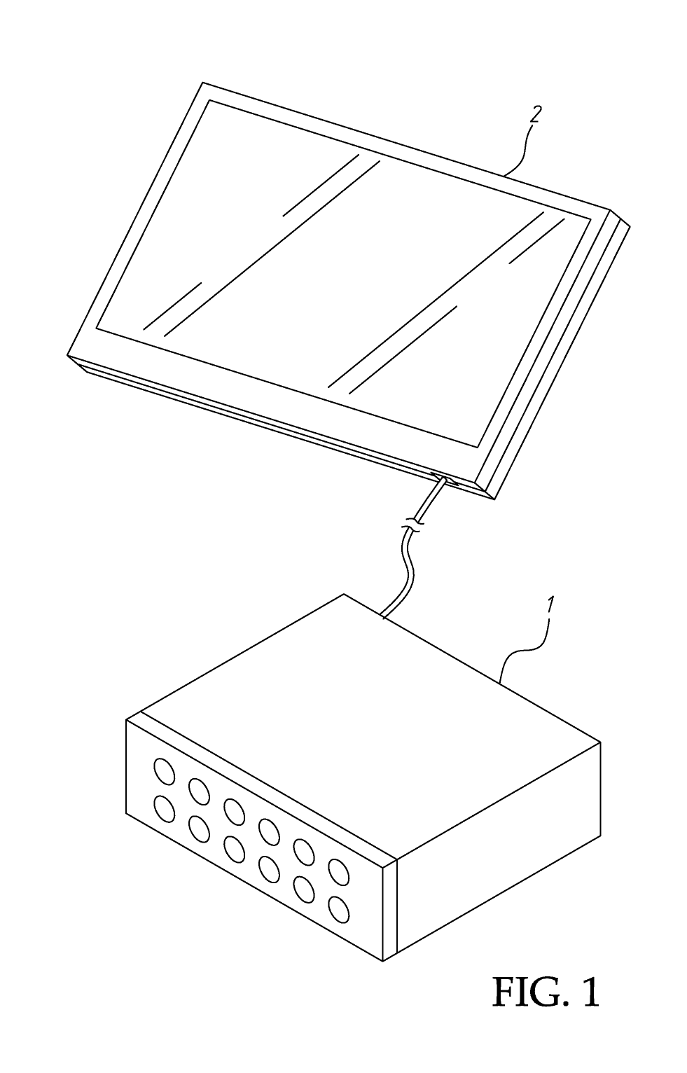

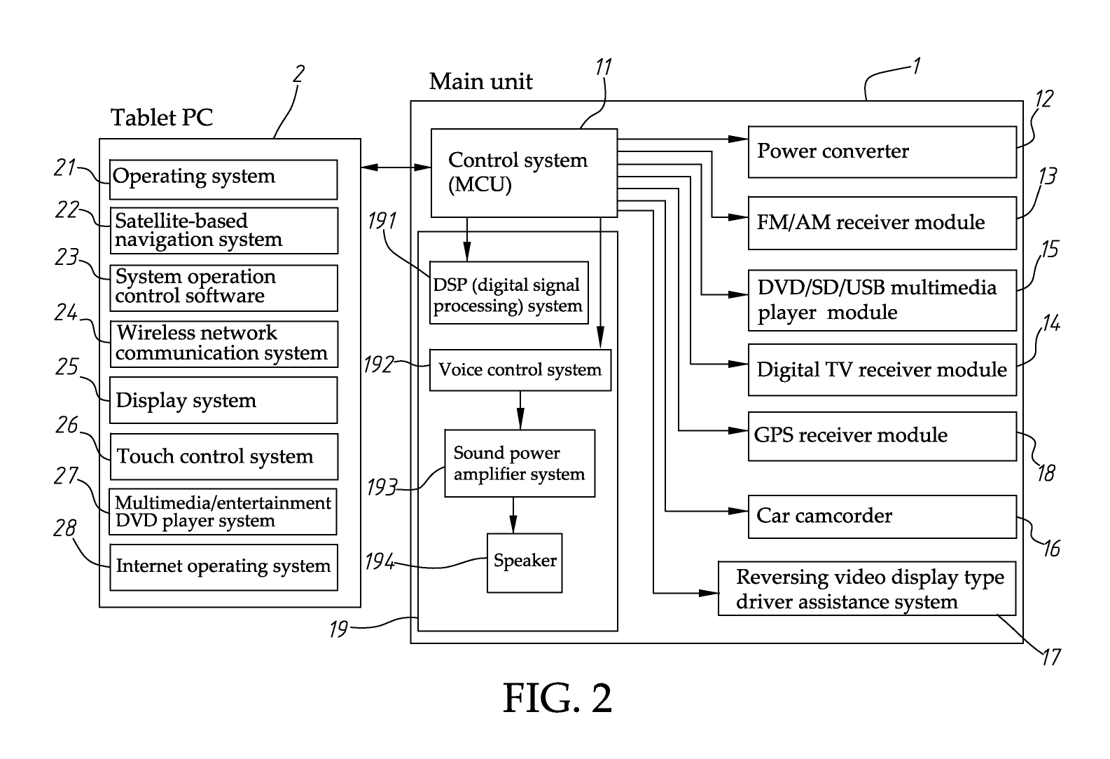

Referring to FIGS. 1 and 2, an intelligent car A/V system in accordance with a first embodiment of the present invention is shown comprising a main unit 1 and a tablet PC 2.

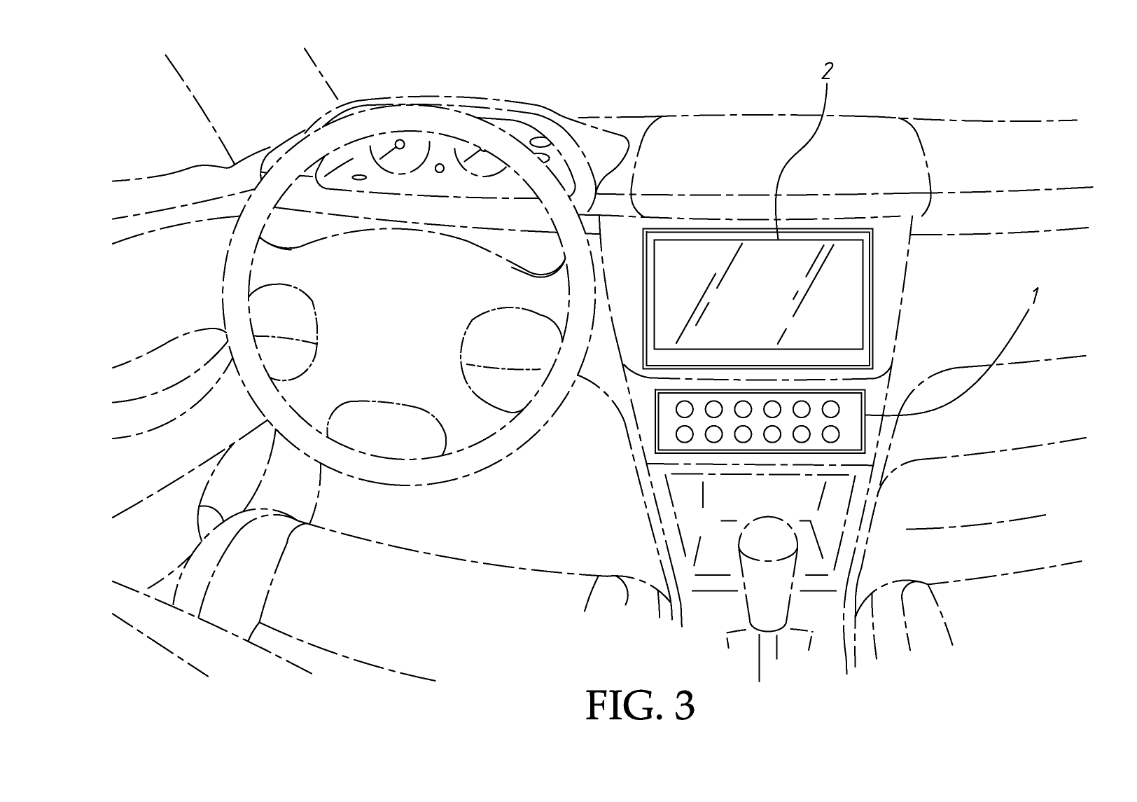

The main unit 1 is installed in the center console of the dashboard in a car (see FIG. 3), comprising a control system 11, a power converter 12 electrically connected with the control system 11 and electrically connectable to the battery power circuit of the car to obtain car battery power from the car and to convert the obtained car battery power into the desired voltage level for the control system 11, a FM/AM receiver module 13, a digital TV receiver module 14, a DVD/SD/USB multimedia player module 15, a car camcorder 16, a reversing video display type driver assistance system 17, a GPS receiver module 18 and an audio amplifier system 19. The FM/AM receiver module 13, the digital TV receiver module 14, the DVD/SD/USB multimedia player module 15, the car camcorder 16, the reversing video display type driver assistance system 17, the GPS receiver module 18 and the audio amplifier system 19 are respectively electrically connected to the control system 11.

Further, the audio amplifier system 19 is similar to a conventional car multimedia player system, comprising a DSP (digital signal processing) system 191, a voice control system 192, a sound power amplifier system 193 and a speaker 194.

Further, the tablet PC 2 is detachably installed in the center console of the dashboard in the car near the main unit 1 (see FIG. 3), comprising an operating system 21, a satellite-based navigation system 22, a system operation control software 23, a wireless network communication system 24, a display system 25, a touch control system 26, a multimedia/entertainment DVD player system 27 and an internet operating system 28.

The tablet PC 2 is electrically connected to the control system 11 of the main unit 1, and can be used as a terminal in the car for playing and displaying audio and video data subject to the control of the system operation control software 23.

After installation of the main unit 1 and the tablet PC 2 in a car, the satellite-based navigation system 22 of the tablet PC 2 can be used and operated as a satellite-based navigation driver assistance system. Further, the wireless network communication system 24 of the tablet PC 2 can be connected to the Internet wirelessly by means of mobile telephone network IP sharing. Further, by means of the vehicle bus standard of controller-area network (CAN or Can-bus) in connection with the car computer system, the tablet PC 2 of the intelligent car A/V system of the invention can be used as a display terminal of the car electronic system. Further, the intelligent car A/V system of the invention can be can be connected to the Internet by means of a built-in 3G/4G communication system, or by an external 3G/4G communication system through the connection of a USB interface. Further, by means of an internal Bluetooth communication system in the tablet PC 2, the intelligent car A/V system of the invention can be can be used as a hand-free handset of a mobile telephone system. The internal Bluetooth communication system of the tablet PC 2 can be communicated with an external Bluetooth communication system for audio and video data output. Audio signal can be amplified by the main unit 1 before output.

After disconnection from the main unit 1, the tablet PC 1 is used as an independent personal computer that has the main characteristics of a conventional personal computer.

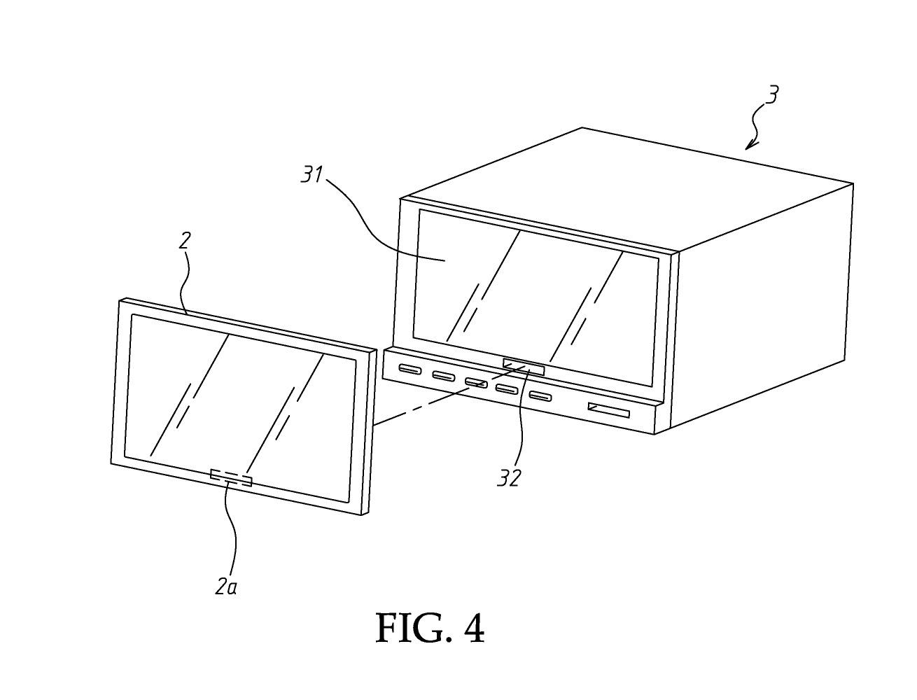

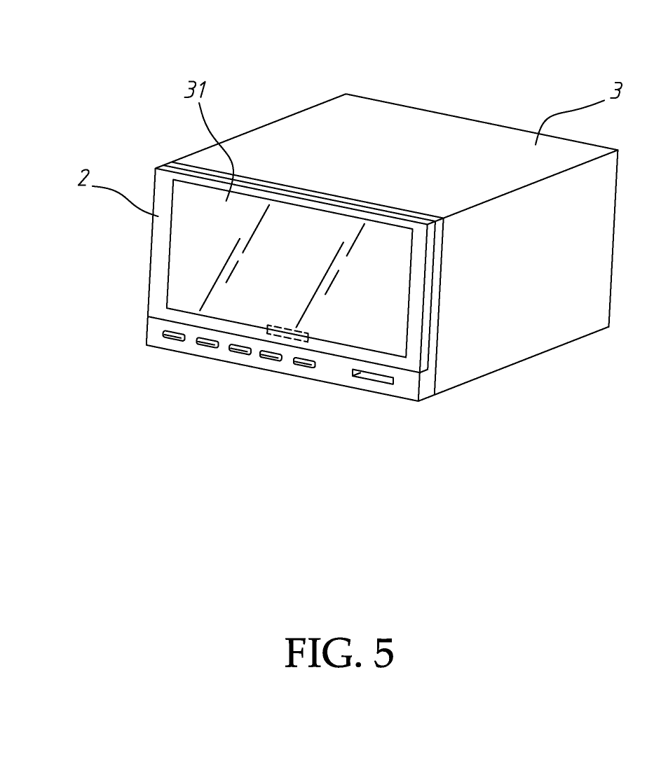

FIGS. 4 and 5 illustrate an intelligent car A/V system in accordance with a second embodiment of the present invention. According to this second embodiment, the intelligent car A/V system comprises a main unit 3 and a tablet PC 2. The main unit 3, except the features of the main unit of the aforesaid first embodiment, the main unit 3 of this second embodiment further comprises a LCD screen 31 located on the front side thereof and a male electrical connector 32 located on the front side below the LCD screen 31. The tablet PC 2 is substantially similar to that of the aforesaid first embodiment with the exception that the tablet PC 2 of this second embodiment further comprises a female electrical connector 2a located on the back side thereof and electrically and detachably connectable to the male electrical connector 32 of the main unit 3. Thus, the installation of the tablet PC 2 in accordance with the second embodiment of the present invention is quite simple.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. An intelligent car A/V system for use in a car, comprising:
a main unit installed in a center console of a dashboard of a car, said main unit comprising a control system, a power converter electrically connected with the control system and electrically connectable to a battery power circuit of said car to obtain car battery power from said car and to convert the obtained car battery power into a desired voltage level for said control system, and a FM/AM receiver module, a digital TV receiver module, a DVD/SD/USB multimedia player module, a car camcorder, a reversing video display type driver assistance system, a GPS receiver module and an audio amplifier system respectively electrically connected with said control system; and
a tablet personal computer detachably mountable at said center console of said dashboard of said car and electrically connected to said control system of said main unit for enabling said control system to control the operation of said tablet personal computer, said tablet personal computer comprising an operating system, a satellite-based navigation system, a system operation control software, a wireless network communication system, a display system, a touch control system, a multimedia/entertainment DVD player system and an internet operating system.

2. The intelligent car A/V system as claimed in claim 1, wherein said audio amplifier system comprises a DSP (digital signal processing) system, a voice control system, a sound power amplifier system and a speaker.

3. The intelligent car A/V system as claimed in claim 1, wherein said main unit further comprises a LCD screen located on a front side thereof and a male electrical connector located on said front side below said LCD screen; said tablet personal computer comprises a female electrical connector located on a back side thereof and electrically and detachably connectable to said male electrical connector of said main unit.
